(19) United States
(12) Patent Application Publication
(10) Pub. No.: US 2012/0018678 A1
(43) Pub. Date: Jan. 26, 2012

(54) Selective Oxidation Agent of Hydrocarbons to Synthesis Gas Based on Separate Particles of O-Carrier and Hydrocarbon Activator

(75) Inventors: Deng-Yang Jan, Elk Grove Village, IL (US); Joel T. Walenga, Lake Zurich, IL (US); Kurt M. Vanden Bussche, Lake in the Hills, IL (US); Joseph A. Kocal, Gienview, IL (US); Lisa M. King, Westchester, IL (US)

(73) Assignee: UOP LLC, Des Plaines, IL (US)

(21) Appl. No.: 13/247,048

(22) Filed: Sep. 28, 2011

Related U.S. Application Data
(63) Continuation of application No. 11/939,781, filed on Nov. 14, 2007.

(51) Int. Cl. C01B 3/34

(52) U.S. Cl. 252/373

(57) ABSTRACT

A solid material is presented for the partial oxidation of natural gas. The solid material includes a solid oxygen carrying agent and a hydrocarbon activation agent. The material precludes the need for gaseous oxygen for the partial oxidation and provides better control over the reaction.

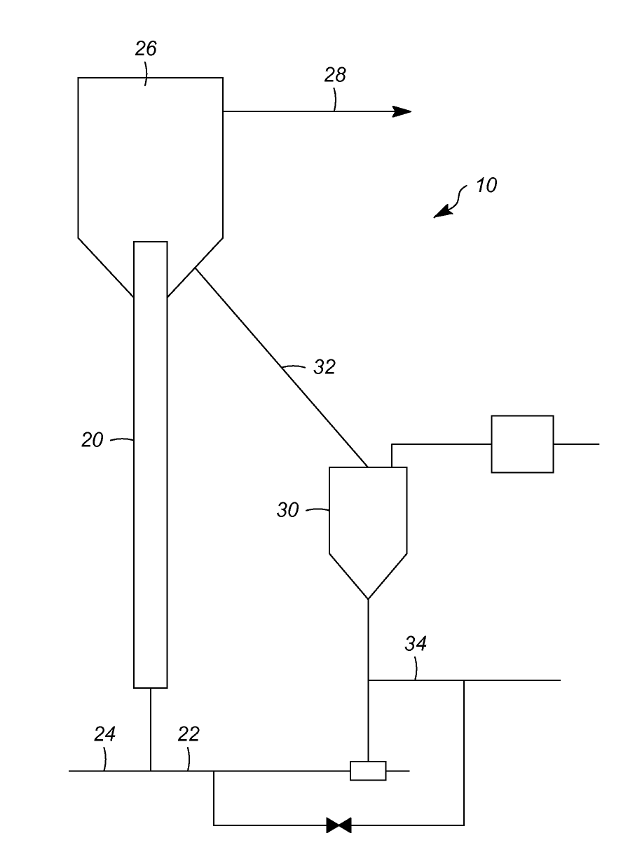

### CROSS-REFERENCE TO RELATED APPLICATION

This application is a Continuation of prior copending U.S. application Ser. No. 11/939,781 which was filed on Nov. 14, 2007, the contents of which are incorporated herein by reference thereto.

### BACKGROUND OF THE INVENTION

The present invention relates to a material for use in converting natural gas into other commercial products. Specifically, the invention relates to the production of syngas from natural gas using a solid oxidizing agent.

Natural gas generally refers to light gaseous hydrocarbons, and especially comprising methane. Natural gas also contains hydrocarbons such as ethane, propane, butanes, and the like. Natural gas is recovered from underground reservoirs, and is commonly used as an energy source for heating and power generation. Typically, natural gas is recovered at high pressure, processed and fed into a gas pipeline under pressure. Natural gas can comprise undesirable components, such as carbon dioxide, nitrogen and water, which can be removed with technology commonly available. One example is the use of adsorbents for removing non-hydrocarbon components of the natural gas, and or sulfur compounds.

Natural gas is usually processed to recover heavier hydrocarbon components found in the natural gas, and to increase the relative methane content. Components recovered from natural gas include ethane, propane, butanes, and the like, as well as unsaturated hydrocarbons, leaving methane as the principal component of the processed natural gas.

Natural gas is most commonly handled in gaseous form, and transported by pipeline to processing plants, and then onto gas pipelines for transmission and distribution. However, there is much natural gas that is located in remote locations, and needs to be transported without the ability to feed the natural gas into a pipeline. In addition natural gas, or more precisely methane, can be processed to produce higher molecular weight hydrocarbon products for use as liquid fuels, lubricants, or monomers for plastics.

The need for methods of processing methane can improve the recovery and distribution of natural gas, especially when the natural gas is situated in distant and remote locations where the economics depend on how the natural gas is brought to market.

### SUMMARY OF THE INVENTION

The production of syngas from methane involves converting methane to hydrogen and carbon monoxide. The present invention provides a material for use in the partial oxidation of methane without the need of gaseous oxygen. The material comprises an oxygen carrier component and a hydrocarbon activation component. When the material is mixed with methane in a reactor under reaction conditions, the methane is converted to syngas. The components for the oxygen carrier include oxides of transition metals from Groups 4B, 5B, 6B, 7B, 8B, 1B and 2B of the periodic table. The components for the oxygen carrier can also include complex metal oxide compounds having several metal components, such as perovskites, brownmillerites and fluorites. The material also includes a hydrocarbon activation component, where the activation component includes a metal selected from the Groups 6B, 7B and 8B of the periodic table.

Other objects, advantages and applications of the present invention will become apparent to those skilled in the art from the following detailed description and drawing.

### BRIEF DESCRIPTION OF THE DRAWING

The FIGURE is a diagram of a reactor for using the solid oxidizing material.

### DETAILED DESCRIPTION OF THE INVENTION

Natural gas is traditionally collected and transported to plants for processing. The primary use of natural gas is for heating, and is processed by removing water, inert gases, and natural gas liquids, or higher molecular weight hydrocarbons found in natural gas. The natural gas is then compressed, or liquefied for transport. However, one new technology is to convert natural gas to methanol for transport as a liquid. This saves on compression costs, and/or liquefaction costs, and provides for a safer material to transport.

Another process for changing the traditional compression and liquefaction of natural gas, is to convert the natural gas to syngas, or synthesis gas. The first steps will be to remove inert components in the natural gas, such as nitrogen, argon, and carbon dioxide. Natural gas liquids will also be recovered and directed to other processing or transport. The treated natural gas will comprise primarily methane and some ethane with small amounts of higher alkanes, such as propane. Preferably, the natural gas comprises more than 90% methane. Syngas can provide for the generation of liquids from the methane. There two primary methods of producing syngas from methane. One method is steam reforming where methane and steam react to form carbon monoxide and hydrogen. Steam reforming is energy intensive in that the process consumes over 200 kJ/mole of methane consumed and therefore requires a furnace or other source of continuous heat. A second method is partial oxidation. Partial oxidation comprises burning methane in an oxygen lean environment where the methane is partially oxidized to carbon monoxide along with the production of hydrogen and some steam. Partial oxidation is exothermic and yields a significant amount of heat. Because one reaction is endothermic and the other is exothermic, these reactions are often performed together for efficient energy usage. Combining the steam reforming and partial oxidation yields a third process wherein the heat generated by the partial oxidation is used to drive the steam reforming to yield a syngas. However, the partial oxidation needs a higher concentration of oxygen than is found in air and the energy associated with the separation of air off-sets the advantage of the energy needed for steam reforming.

Processes for syngas formation are well known and can be found in U.S. Pat. No. 7,262,334 and U.S. Pat. No. 7,226,548, and are incorporated by reference in their entirety. The resulting syngas comprises carbon monoxide (CO), water (H₂O), and hydrogen (H₂). The syngas can be catalytically converted to larger hydrocarbons through Fischer-Tropsch synthesis. Fisher-Tropsch synthesis is a known process for the conversion of oxidized carbon to hydrocarbon liquids, as shown in U.S. Pat. No. 4,945,116. Typically the oxidized carbon is carbon monoxide and the source is from the partial combustion of coal.

The oxidation of hydrocarbons can be carried out with a catalyst such as for the production of butane to maleic anhydride or propylene to acrolein, as shown in U.S. Pat. No. 6,437,193 and U.S. Pat. No. 6,310,240. These processes are for the insertion of oxygen into a hydrocarbon to produce a desirable oxygenate. The aim of partial combustion of a light hydrocarbon, such as methane, is to strip all of the hydrogen from the hydrocarbon and to produce a gas of CO and H₂ for subsequent generation of larger molecules. While the transport mechanism shows that some of the oxygen can come from solids bearing the oxygen, the processes are operated at lower temperatures than partial oxidation for the production of syngas. Indeed, the processes show that at high temperatures the solids are readily reoxidized for regeneration at temperature around 500° C., indicating that the equilibrium of metals with their oxides is unfavorable at higher temperatures.

However, by controlling the process and by not adding any gaseous oxygen as in the references, and by having the oxygen from the solid oxides taken away with the carbon atoms during the partial combustion, it was found that a favorable control over the production of syngas is achieved through the use of a solid oxidizing agent in a co-current reactor.

The use of a solid oxidizing agent requires that the solid material be readily capable of reduction-oxidation reactions under reaction conditions. It has been found that a useful material for the production of syngas from natural gas comprises an oxygen carrier component for supplying the oxygen to the natural gas, and a hydrocarbon activation component that enhances the reaction of partial oxidation of the natural gas. While the description refers to natural gas, and specifically methane, the material can also be used to convert any hydrocarbon to syngas. The oxygen carrier component can include elements of reduction-oxidation and elements to enhance reduction-oxidation. The elements or reduction-oxidation include the materials for carrying the oxygen to the reaction, reacting with the natural gas, especially the methane, and are capable of being regenerated. The elements for reduction-oxidation include oxides of transition metals from Groups 4B, 5B, 6B, 7B, 8B, 1B and 2B of the periodic table. The elements for reduction-oxidation also include oxides of elements from Groups 3A, 4A and 5A from the periodic table, and oxides cerium. A preferred group of metal oxides from these elements are oxides of manganese (Mn), iron (Fe), copper (Cu), nickel (Ni), zinc (Zn), cerium (Ce), vanadium (V), niobium (Nb), tantalum (Ta), titanium (Ti), zirconium (Zr), hafnium (Hf) and mixtures thereof. Elements to enhance reduction-oxidation include rare earth elements, alkali elements and alkaline earth elements.

The materials for the oxygen carrier component can comprise mixtures of materials that include metal oxides. Among the materials are compounds comprising transition metals and alkaline earth metals oxygen complexes, or comprising alkaline earth metal and Group 3A metal oxygen complexes such as perovskites, brownmillerites, fluorites and pyrochlore, which are specific types of crystalline structures of metal oxygen complexes. In the case of fluorites, while there are metal oxides having a fluorite structure, and it is these fluorites to which the invention applies. The metal oxides having a fluorite structure, are rare earth metal oxides having a cubic structure, and typically of the form MO₂, where M is a rare earth oxide, and includes metals in the lanthanide series and actinide series. An example of a rare earth oxide with a fluorite structure is CeO₂. The fluorites can also be doped with other metal oxides, including rare earth oxides and oxides of metals from Groups 3A, 4A and 5A. Pyrochlores are metal oxygen complexes having a nominal composition of M1₂M2₂O₇, brownmillerites are metal oxygen complexes having a nominal composition of M1₂M2₂O₅, and perovskites are metal oxygen complexes having a nominal composition of M1M2O₃, where M1 and M2 are transition metals, rare earth metals, alkaline earth metal, and including combinations thereof. Although nominal compositions have been listed for these crystalline structures, other compositions are possible and are included in the invention. It is preferred that the oxygen carrier component has a redox oxygen capacity of 1 wt % or greater.

The material for this invention includes a hydrocarbon activation component for enhancing the reaction rate of the partial oxidation of the natural gas. The activation component includes a metal selected from the Groups 6B, 7B and 8B of the periodic table, or includes a metal selected from one or more of: chromium (Cr), molybdenum (Mo), tungsten (W), manganese (Mn), technetium (Te), rhenium (Re), iron (Fe), cobalt (Co), nickel (Ni), ruthenium (Ru), platinum (Pt), palladium (Pd), rhodium (Rh), iridium (Ir), and osmium (Os). Preferably, the activation material is selected from one or more of chromium (Cr), molybdenum (Mo), tungsten (W), nickel (Ni), ruthenium (Ru), platinum (Pt), palladium (Pd), rhodium (Rh), and iridium (Ir).

The material of the present invention comprises solid particles wherein the oxygen carrier component has a concentration from 5 to 99.999 wt % and the hydrocarbon activation component has a concentration from 0.001 to 50 wt %. Preferably, the solid particles wherein the oxygen carrier component has a concentration from 10 to 70 wt % and the hydrocarbon activation component has a concentration from 0.001 to 20 wt %. A binder can be added to increase the physical strength of the material. When the composition is such that the sum of the hydrocarbon activation component and the oxygen carrier component is less than 100%, the difference comprises a binder material.

Examples of preferred binder materials include, but are not limited to, alumina, silica, aluminum phosphate, silica-alumina, zirconia, titania, and mixtures thereof. In referring to the types of binders that may be used, it should be noted that the term silica-alumina does not mean a physical mixture of silica and alumina but means an acidic and amorphous material that has been cogelled or coprecipitated. In this respect, it is possible to form other cogelled or coprecipitated amorphous materials that will also be effective as binder materials. These include silica-magnesias, silica-zirconias, silica-thorias, silica-berylias, silica-titanias, silica-alumina-thorias, silica-alumina-zirconias, aluminophosphates, mixtures of these, and the like.

The material of the present invention can be a physical mixture, or the material can be combined into single particles. When the invention comprises a physical mixture of the oxygen carrier component and the hydrocarbon activation component, the particle sizes of each of the components have a size of less than 3000 micrometers. When the components of the material are combined into single particles, the combined particles can have a size of less then 6000 micrometers. When referring to size, the size is the nominal equivalent diameter of the particles if the particles were spherical in shape. The particles are not limited to being spherical in shape, but can be extruded cylinders, or other shapes that result from the production process to fabricate the particles.

Using this material, the partial oxidation of methane is performed without gaseous oxygen present. The advantage with this method is that during the process if there is over oxidation of the methane to produce carbon dioxide (CO₂), the process is simultaneously reducing the solid oxidizing agent, and as the product comprising carbon dioxide and reduced solid oxiding agent progress through the reactor, the equilibrium with shift such that the carbon dioxide with be reduced to carbon monoxide (CO).

The process comprises contacting a natural gas stream with an oxidized solid material in a reaction zone, thereby generating a syngas and a reduced solid material. The reduced solid material and syngas are separated, and the reduced solid material is passed to a regeneration zone. In the regeneration zone, the reduced solid material is regenerated through a reaction with an oxidizing gas thereby generating the oxidized solid material.

The process can be shown with respect to a looping reactor for use in generating the syngas. The reactor 10, as shown in the FIGURE, is a cocurrent flow reactor, and comprises a reaction section 20, and a regeneration section 30. The oxidized solid material is heated and fed to the reaction section 20 through a solid feed conduit 22. Heat is added to the process through the heated solid material. Methane, or natural gas, is fed to the reaction section 20 through a natural gas conduit 24. The methane and the oxidized solid material travel cocurrently up the reaction section 20 where the syngas is formed. The oxidized solid material is reduced to a reduced solid material and the syngas and reduced solid material separate in a separation section 26. The syngas is directed through a produce conduit 28 and the reduced solid material is falls down the reactor 10 outside the reaction section 20. The reduced solid material is directed through a conduit 32 to the regeneration section 30. In an alternate embodiment, the process can include adding steam to the reaction section 20. The steam can be added with the oxidized solid material through the solid feed conduit 22, thereby facilitating the transport of the oxidized solid material, or the steam can be added with the natural gas through the natural gas conduit 24, or the steam can be added through an independent port (not shown) for more individual control over the amount of steam added to the process. Steam also provides heat that can facilitate the reactions to produce syngas.

The formation of syngas is a high temperature reaction with the temperature between 500° C. and 900° C., and preferably between 600° C. and 850° C. The reaction conditions include a pressure in the reactor is between 0.103 MPa (15 psia) and 6.9 MPa (1000 psia), and preferably between 1.72 MPa (250 psia) and 4.14 MPa (600 psia).

In the regeneration section 30, an oxidizing gas is admitted to the section 30 through an oxidizing gas inlet 34. The oxidizing gas can comprise air or oxygen. The oxidizing agent needs to contain oxygen, as the oxygen will be transferred to the syngas during the reaction with natural gas. The oxidizing gas can further include steam. The steam provides several advantages to the regeneration process. The steam provides heat, and increases the volume of gas that facilitates lifting the solid through the regeneration section 30.

In another embodiment, the process comprises contacting the natural gas stream with a solid oxide material and a hydrocarbon activation material under reaction conditions, thereby generating a syngas stream and a reduced solid material. The solid oxide, natural gas and hydrocarbon activation material are fed into a reactor and carried co-currently through the reactor. After exiting the reactor the reduced solid and hydrocarbon activation material are separated from the syngas and directed to a regeneration zone for reoxidizing the reduced solid, thereby regenerating the solid oxide for reuse in the reactor.

While the invention has been described with what are presently considered the preferred embodiments, it is to be understood that the invention is not limited to the disclosed embodiments, but it is intended to cover various modifications and equivalent arrangements included within the scope of the appended claims.

1. A process for the production of syngas from a hydrocarbon stream, comprising:
contacting the hydrocarbon stream with an oxidized solid material in a reaction zone under reaction conditions, including a reaction temperature greater than 500° C., wherein the gas stream contains no gaseous oxygen, thereby generating a syngas and a reduced solid material;
separating the syngas and reduced solid material to generate a syngas product stream and a solid material stream;
passing the solid material stream to a regeneration section; and
oxidizing the solid material with an oxidizing gas under oxidation conditions to generate an oxidized solid material.

2. The process of claim 1 wherein the oxidized solid material comprises:
an oxygen carrier component; and
a hydrocarbon activation component.

3. The process of claim 1 wherein the oxidized solid material comprises:
elements of reduction-oxidation; and
elements to enhance reduction-oxidation.

4. The process of claim 3 wherein the elements of reduction-oxidation are selected from the group consisting of oxides of transition metals of Groups 4B, 5B, 6B, 7B, 8B, 1B, 2B, oxides of main elements of Groups 3A, 4A, 5A, oxides of cerium, and mixtures thereof

5. The process of claim 3 wherein the elements to enhance the reduction-oxidation are selected from the group consisting of rare earth elements, alkali elements, alkaline earth elements, and mixtures thereof

6. The process of claim 1 wherein the solid oxidized material is a metal oxide or mixture of metal oxides selected from the group having structures consisting of perovskites, brownmillerites, fluorites, pyrochlore and mixtures thereof.

7. The process of claim 2 wherein the hydrocarbon activation component is selected from the group consisting of metals of Groups 6B, 7B, 8B and mixtures thereof.

8. The process of claim 1 wherein the oxidizing gas comprises air or oxygen.

9. The process of claim 1 wherein the hydrocarbon stream comprises natural gas.

10. The process of claim 1 wherein the reaction conditions include a pressure between 103 kPa and 6.9 MPa.

11. The process of claim 1 wherein the temperature of the reaction is between 600° C. and 850° C.

12. The process of claim 1 wherein the oxidized solid material has a redox oxygen capacity of 1 wt % or greater.

13. The process of claim 2 wherein the oxidized solid material has the hydrocarbon activation component in a concentration from 0.001 to 20 wt %, and has the oxygen carrier component in a concentration from 10 to 70 wt %.

14. The process of claim 1 wherein the oxidized solid material comprises particles having a size less than 3000 micrometers.

15. The process of claim 2 wherein the oxygen carrier component and the hydrocarbon activation component are a physical mixture of particles.

16. The process of claim 2 wherein the oxygen carrier component and the hydrocarbon activation component are combined into single particles.
